(19) United States
(12) Patent Application Publication
(10) Pub. No.: US 2025/0085755 A1
(43) Pub. Date: Mar. 13, 2025

(54) APPLIANCE OPERATION MONITOR, SYSTEM, AND METHOD

(71) Applicant: Gary Allen Naden, Bozeman, MT (US)

(72) Inventor: Gary Allen Naden, Bozeman, MT (US)

(21) Appl. No.: 18/466,479

(22) Filed: Sep. 13, 2023

(51) Int. Cl. G06F 1/26; G06F 1/30

(52) U.S. Cl. CPC G06F 1/263; G06F 1/266; G06F 1/30

(57) ABSTRACT

An electric appliance health monitoring device, and a method for detecting and reporting appliance failure or pending failure are provided. The device includes voltage conversion and power management with a rechargeable battery capability to provide operating power for device function. The device provides power to an electrical appliance, monitoring the appliance voltage and current usage with a current sensor to detect power failure or appliance anomalous operation. The device includes a wireless transceiver to communicate device status and report appliance anomalous operation. The method includes statistical analysis with thresholding and predictive analytics for determining failure or pending failure of an appliance. This method also provides for remote notification and control of the anomaly detection process using long-range radio and data communications methods.

### TECHNICAL FIELD

This disclosure relates generally to powered appliance remote monitoring systems. More specifically, this disclosure relates to monitoring an appliance electrical current usage to determine anomalous operation of the monitored appliance.

### BACKGROUND

Electrical equipment and appliances fail resulting in costly loss and repair expenses that could be mitigated with timely notification of failure or pending failure. Food storage systems such as refrigeration units and freezers can fail intermittently which can lead to undetected spoilage and potentially create illness if consumed. Fluid management systems such as pumps can fail causing overflow of reservoirs, tanks or holding pits which can lead to costly damage and environmental impact causing costly remediation. Any device that uses electricity can fail due to supply power failure such as circuit-breaker action or utility service interruptions or electrical equipment failure. When failure happens, the consequences of the utility being fulfilled by the device may be minimized or avoided if a notification of failure, or pending failure, is conveyed to mitigating systems or persons. Monitoring and detecting supply power and appliance operational current coupled with a long-range communication capability can create a monitoring system capable of detecting complete failures and predict pending failures.

### SUMMARY

This disclosure provides an appliance operation system and method.

In a first embodiment, an electronic device is provided. The electronic device may include a voltage converter, a current sensor, a power manager with rechargeable battery, a controller and a wireless transceiver. The voltage converter is configured to receive electrical power from international standard sources, such as a wall plug receptacle. The voltage converter converts the electrical source voltage to a voltage suitable for the device operation. The current sensor measures electrical current from the device electrical input passed through the device to the appliance being monitored. The current sensor is therefore measuring the load current of the appliance associated with the device. The power manager accepts the voltage from the voltage converter and provides operating voltage for the device. The power manager also manages recharge and draw from an associated rechargeable battery. The power manager performs automatic failover between the supply voltage from the voltage converter and the rechargeable battery to ensure the device is supplied with continuous voltage for operation. The controller performs the operating task of the appliance current monitoring from the current sensor as well as monitoring device supply voltage. The controller collects and stores data samples and uses statistical analysis comparing recent operation with prior historical operation to ascertain anomalous behavior. The controller utilizes the wireless transceiver to communicate device status and anomalous alert notifications and to receive configuration for operation.

In a second embodiment, an appliance monitoring system is provided. The system may include the electronic device as described in the first embodiment, however some of the computational operations for appliance anomalous determination may be performed in a remote computer system. In this second embodiment, the controller function is therefore performed collaboratively with the device performing at a minimum the appliance current and voltage measurements, and the remote computer system performing some or all of the statistical anomalous detection and notification operations.

In a third embodiment, a method is provided. The third embodiment method includes measuring an input supply voltage for an appliance monitoring system, and converting the input supply voltage for use by a monitoring system, and a power management method for using the converted voltage along with a rechargeable battery system to provide power for appliance monitoring operations. The method provides measurements to be sampled by the monitoring system and used by a controller to perform temporal statistical analysis processes for determination of anomalous appliance and monitor system operation. The method also describes a communication method for the monitoring system to receive configuration and reprogramming operations for the monitoring system and for sending alert notifications for appliance anomalous operation.

In a fourth embodiment, a method is provided. The fourth embodiment method includes the methods described in the third embodiment where the data analysis for determination of anomalous appliance and monitor system operation is performed in both the monitoring system and a remote computer system. In this fourth embodiment, the monitoring system may use the communication method described in the third embodiment to send raw sampled data, or partial analysis of the data to a remote computer system. The remote computer system would then complete the temporal statistical analysis for final determination of anomalous appliance operation.

Other technical features may be readily apparent to one skilled in the art from the following figures, descriptions, and claims.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a block diagram of an embodiment of an appliance Monitor in accordance with features of the present disclosure;

FIG. 2 illustrates a block diagram of another embodiment of an appliance Monitor in accordance with features of the present disclosure;

FIG. 3 is a diagram that illustrates an appliance Monitor system in accordance with features of the present disclosure;

FIG. 4 is a graph that illustrates a data measurement sample example depicting measurement of an appliance run-time interval in accordance with an embodiment of the present disclosure;

FIG. 5 is a graph that illustrates a data measurement sample example depicting measurement of an longer period to include multiple appliance run-time intervals in accordance with an embodiment of the present disclosure;

FIGS. 6A and 6B are graphs that illustrate an example of temporal statistical analysis for determination of appliance anomalous operation in accordance with an embodiment of the present disclosure;

FIGS. 7A and 7B are graphs that illustrate an example of temporal statistical analysis for determination of appliance anomalous operation in accordance with an embodiment of the present disclosure; and

FIGS. 8A and 8B are graphs that illustrate a false alarm rate threshold method in accordance with an embodiment of the present disclosure.

### DETAILED DESCRIPTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Those of ordinary skill in the art realize that the following descriptions of the embodiments of the present invention are illustrative and are not intended to be limiting in any way. Other embodiments of the present invention will readily suggest themselves to such skilled persons having the benefit of this disclosure. Like numbers refer to like elements throughout.

Although the following detailed description contains many specifics for the purposes of illustration, anyone of ordinary skill in the art will appreciate that many variations and alterations to the following details are within the scope of the invention. Accordingly, the following embodiments of the invention are set forth without any loss of generality to, and without imposing limitations upon, the invention.

In this detailed description of the present invention, a person skilled in the art should note that directional terms, such as “above,” “below,” “upper,” “lower,” and other like terms are used for the convenience of the reader in reference to the drawings. Also, a person skilled in the art should notice this description may contain other terminology to convey position, orientation, and direction without departing from the principles of the present invention.

Furthermore, in this detailed description, a person skilled in the art should note that quantitative qualifying terms such as “generally,” “substantially,” “mostly,” and other terms are used, in general, to mean that the referred to object, characteristic, or quality constitutes a majority of the subject of the reference. The meaning of any of these terms is dependent upon the context within which it is used, and the meaning may be expressly modified.

It may be advantageous to set forth definitions of certain words and phrases used throughout this patent document. The term “voltage” and its derivatives refer to any electrical potential, whether direct current or alternating current, measured or used by the device or system described herein, typically measured in units of volts. The term “current” refer to the transfer of electrical signals, typically measured in units of amperes (amps). The term “VAC” refers to volts alternating current, which is a standard notation for international shore power. The term “Monitor” when used in noun form refer to the physical device performing monitoring operations of the present invention. The terms “appliance” or “appliances” or “load” refer to any asset, or device, drawing power through and monitored by the present invention device or system for detection and reporting of anomalous operation. The terms “remote computer system” or “remote server system” refer to any computational system physically remote from the monitoring system and appliance. The term “internet” refers to any long-range, distributed communications systems providing connectivity of data systems. The term LTE refers to cellular long term evolution service, also known as 4G or 5G or variants thereof. The term IT refers to the Internet of Things, which includes any data-only connectivity service connecting equipment to the internet. The term ARIMA refers to the autoregressive integrated moving average, which is a statistical method for time series analysis to better comprehend the data or to forecast upcoming series points. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code.

Definitions for other certain words and phrases are provided throughout this patent document. Those of ordinary skill in the art should understand that in many if not most instances, such definitions apply to prior as well as future uses of such defined words and phrases.

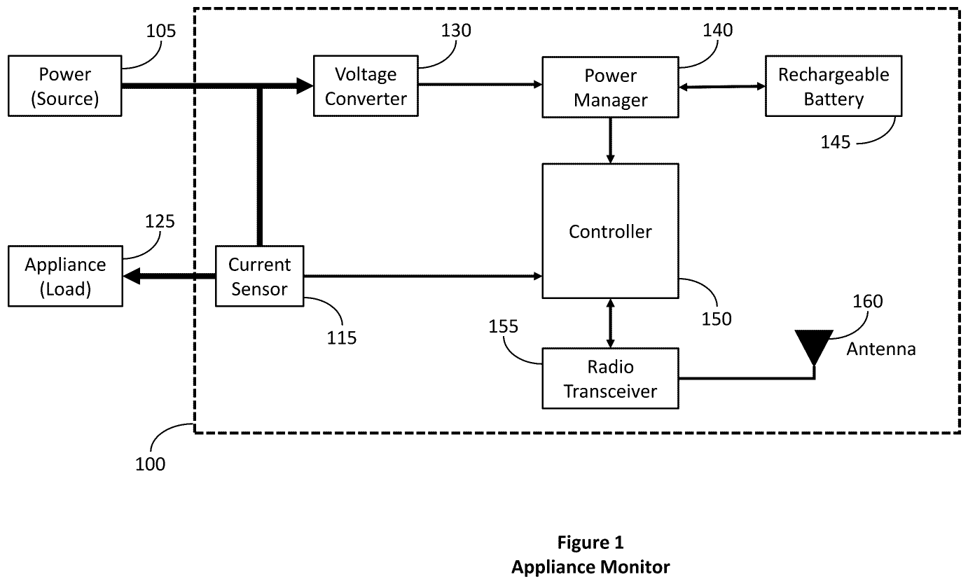

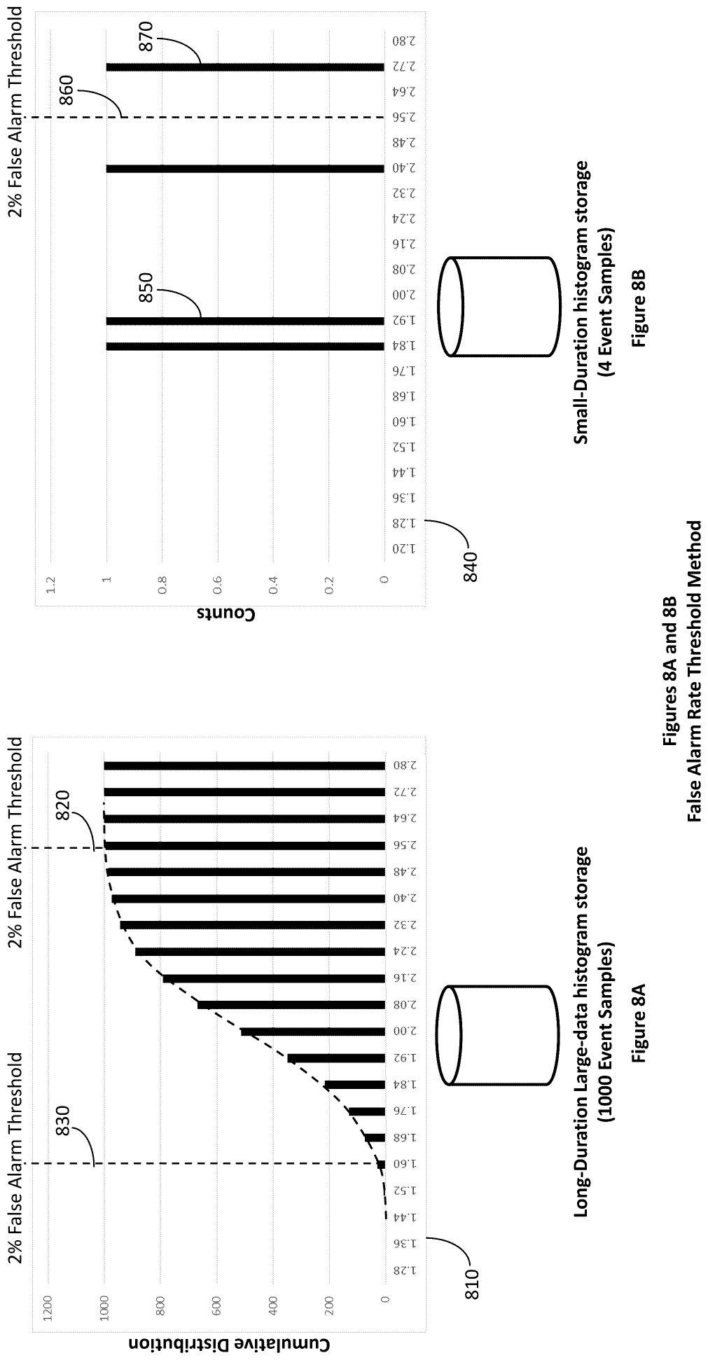

FIGS. 1 and 8, discussed below, and the various embodiments that are used to describe the principles of the present disclosure in this patent document are by way of illustration only and should not be construed in any way to limit the scope of the disclosure. Those skilled in the art will understand that the principles of the present disclosure may be implemented in any suitably arranged sensor with wireless communication capabilities.

FIG. 1 illustrates an example application Monitor system 100 according to this disclosure. The embodiment of the system 100 shown in FIG. 1 is for illustration only. Other embodiments of the system 100 can be used without departing from the scope of this disclosure.

The Monitor 100 accepts operating power 105 for operation, typically provided by facility power utility, such as 115 VAC in North America or 230 VAC in European facilities. This power is the power that would otherwise power the equipment or appliance directly 125. For the purposes of this disclosure, the word “appliance” shall mean any electrical asset, or device, drawing power through and monitored by the present invention device or system for detection and reporting of anomalous operation. The Monitor 100 includes the functions for performing anomalous detection of the appliance 125 being monitored and performs voltage conversion 130 to convert the input power 105 to a voltage suitable for use by the Monitor device. The converted voltage is used by a power manager 140 that performs four primary functions autonomously, 1) monitoring input power from the voltage converter 130, 2) managing recharging of the associated rechargeable battery 145, 3) monitoring the rechargeable battery input voltage coming from the rechargeable battery 145, and 4) autonomously selecting the best input voltage from either the voltage converter 130 or rechargeable battery 145 to create the Monitor system operating voltage used by the controller 150 and all other associated components of the Monitor 100. The Monitor 100 input utility power 105 is also connected to a current sensor 115 that operates as a pass through to the associated appliance 125. The appliance therefore operates on the utility power 105 passed through the current sensor 115 directly.

The current sensor 115 creates a signal proportional to the current draw of the appliance 125 that is monitored by the controller 150. The controller 150 performs the monitoring function for the device, including monitoring input power systems to detect utility power 105 interruption, or rechargeable battery 145 failure, or power management 140 failure. The controller 150 also performs the monitoring function of the current sensor 115 to detect anomalous current draw from the appliance 125 load. The controller 150 function may be fully contained in a physical device, such as a microprocessor, or may be performed partly in a physical device and algorithmic means such as a remote computer system or server as disclosed below. The controller communicates with remote computer systems and human operators using a radio transceiver 155 with antenna 160. The radio transceiver is bidirectional, allowing for outbound reporting of Monitor status, Monitor subsystem operation, sampled data, sampled pre-processed data and appliance anomalous determination reports, for example.

The Monitor 100 may depict a simplest form of the present invention sensor device. It performs the minimum sensor elements necessary to ascertain source power 105 and appliance 125 failure, and it performs temporal statistical analysis with thresholding operations for ascertaining anomalous appliance operation to provide notification for hard failures of the appliance and soft failures of an appliance that may indicate pending appliance failure.

An example of how the Monitor 100 may be used to detect potential failure of an appliance follows: The Monitor may be plugged into a standard utility wall receptacle that provides 115 VAC shore power for appliance operation. Typically, the appliance 125 is directly plugged into this shore power. In this example, the Monitor is plugged in (or connected to) the 115 VAC power directly. The appliance is then connected to the Monitor power pass through. The appliance operates as normal for the utility of the appliance drawing power through the Monitor. For this example, the appliance may be a freezer containing perishable food. Should the shore power fail, or the freezer fail, the food inside may be exposed to temperatures that create spoiled food. A shore power failure may be intermittent, meaning power may fail for hours, or days, then be restored by the utility. The owner of the freezer may not be aware of the power failure and food spoilage, and upon later access to the re-frozen food may draw and prepare the food for consumption, which could cause illness or death for the consuming party. The present invention may minimize or remove the risks by promptly notifying the owner of the intermittent failure.

Another example using the same scenario is the shore power may fail permanently due to a circuit breaker interruption. In this instance shore power to the facility holding the freezer is not the problem, but the circuit within the facility has failed and may require a manual reset to restore power. If the owner of the freezer does not notice the circuit breaker power interruption, the freezer will warm and the contents will be spoiled. If the duration is long, the freezer itself may be destroyed with the rotting food contents. In either case, the cost of lost food, and potentially lost freezer may be excessive, and avoidable if the owner were to be promptly notified of the failure.

In both preceding examples, the power manager 140 automatically detects shore power failure and switches to the rechargeable battery 145 for operating power, thus enabling the controller 150 to perform the detection and send notification to the owner using the radio transceiver 155.

In yet another example using the same scenario, the freezer itself may fail. In this example, both shore power and circuit power are operating, but the freezer itself may stop drawing current. The controller 150 could detect the change of operation by comparing the most recent current operation pattern against previous (temporal) historic operating data. The change of appliance operation creates a suspicious anomalous event to be communicated to the owner directly, or a remote system using the radio transceiver 155.

Note that this system may not detect all appliance anomalies, in that should the appliance current draw as measured by the current sensor 115 remain unchanged from prior historical observation it remains possible for the Monitor to miss the event. Such missed failures are atypical in that electrical appliances such as freezers in this example will most always have a noted difference in power draw when a failure occurs. For example, a freezer that loses coolant will create a compress low-pressure dropout condition. The freezer will shut down the compressor on a low-, or high-pressure dropout as a safeguard for damage to the compressor. The compressor is the largest power user in the freezer, so this safety feature will create a noted different current signature for the appliance that would be detected by the Monitor system. It is therefore a rare event where an appliance may fail without changing the current use signature. An additional safeguard against this type of failure is to add additional sensors, inside or in part of the appliance itself, to communicate to the Monitor using a short-range radio or wired connection to the controller. This additional safeguard is commonly used for appliance monitor applications as would be appreciated by those skilled in the art.

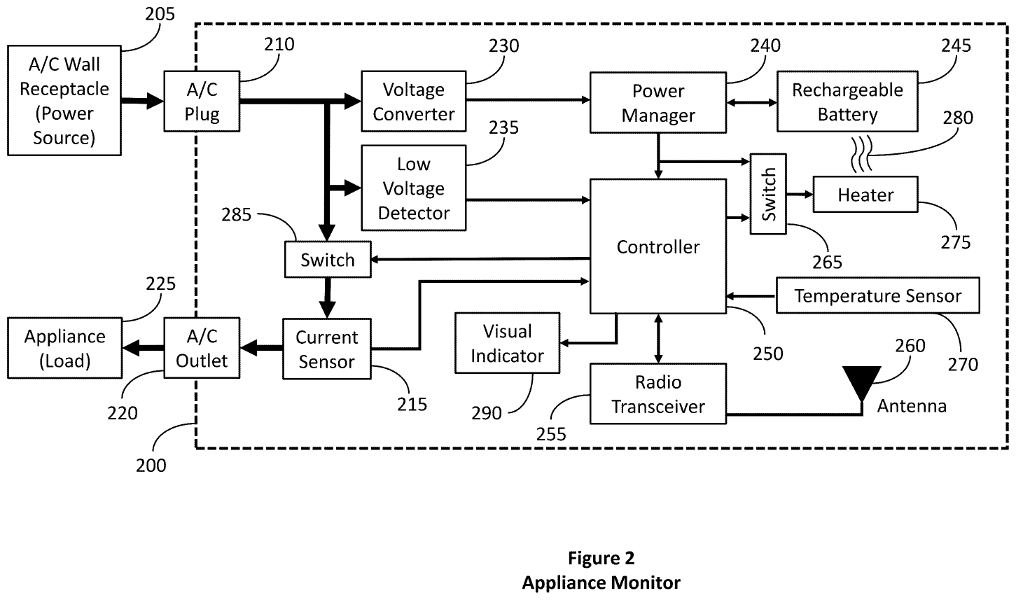

FIG. 2 illustrates the preferred embodiment of the application Monitor system 200 according to this disclosure. The embodiment of the system 200 shown in FIG. 1 is for illustration only. Other embodiments of the system 200 can be used without departing from the scope of this disclosure.

This embodiment described in FIG. 2 incorporates every component discussed in FIG. 1, thus those functions descriptions are included by reference as noted below.

The additions to the Monitor 200 compared with the Monitor 100 include a direct mechanical method for the Monitor to connect to shore power, which may be any international utility power between 90 VAC and 250 VAC, for example. Additionally, the Monitor 200 may accept direct current voltage between 90 VDC and 250 VDC, for example. The shore power utility may be provided to the Monitor 200 using a standard wall receptacle 205 whereby the Monitor 200 plugs directly into the receptacle using an A/C plug 210. Similarly, the Monitor 200 also includes an A/C receptacle enabling users to plug the appliance 225 directly into the Monitor. This configuration provides for direct connection to the shore power and appliance connection to the Monitor, removing the need for a licensed electrician installation.

Monitor 200 includes a disconnect switch 285 that is controlled by the Monitor controller 250. This switch 285 allows the Monitor to cut power to the appliance on anomaly detection as configured by the user. This power cutoff feature may be suitable for some specific applications of the present invention, such as safety or security measures. For example, if the appliance is a garage door opener, and the owner is using the garage opener operating as an alert to an unauthorized intrusion, the Monitor may be configured to trigger on apply current detection to cut power to the opener, thus preventing full operation of the door open process. Other uses for the appliance power switch 285 are apparent.

The Monitor 200 also includes a low voltage detector 235, that differs from the failed voltage detector of the power manager 140 and 240 as described before. The low voltage detector 235 provides a signal to the controller 250 that the input shore power voltage has deviated from normal operating range. For example, if shore power is typically 115 VAC, but a utility brown out occurs and the voltage drops to 90 VAC, the Monitor 200 will still operate, but the low voltage delivered to the appliance 225 may create a condition that damages the appliance. Electrical equipment may not be well protected from low voltage events, and thus the Monitor may use this low voltage detection signal to notify the owner of a low voltage event. Additionally, when coupled with the power interruption switch 285, the controller may be configured to cut power to the appliance 235 for the duration of the low voltage event while simultaneously notifying the owner of the low voltage event and appliance cut power operation, thus protecting the appliance from damage due to low voltage operation.

The Monitor 200 also includes a temperature sensor 270 that provides the environmental operating conditions of the Monitor device. This temperature sensor 270 may be physically integrated into the controller 250 or any other subsystem component of the device providing the same basic function of temperature measurement. The controller 250 may use the temperature sensor measurement to notify owners of temperature outside of the desired operating temperature of the appliance. For example, if the appliance were a water pump and the temperature drops below zero degrees Celsius, the pump may fail due to freezing creating property damage, or an environmental risk due to pump failure. Additionally, the owner may wish to cut power to the pump to mitigate cost of pump damage. In either case, the temperature information may be vitally important in itself.

The temperature sensor 270 data may also be used by the controller to maintain proper power operation over a larger operating temperature range. Rechargeable batteries typically have limited operating temperature ranges. Many battery chemistries, such as lithium ion (Li-ion) use internal dielectric fluid for ion transfer to create voltage and current. The dielectric fluid may freeze, rendering the battery to recharge or discharge, thus rendering a device using the battery inoperable. To mitigate this potential issue and extend operating temperature range of the Monitor 200, a heater 275 is provided. This heater 275 provides heat to the rechargeable battery 245 to allow the Monitor to operate a temperatures below the battery specified low limit. The controller 250 enables and disables the heater 275 using a power switch 265. This temperature sensor with heater feature enables the Monitor to operate in environments exposed to seasonal temperatures, such as garages or facilities with shore power but no facility heat.

The Monitor also may include a user indicator 290 that is a human detectable device conveying Monitor operating status, to include internal hardware failure, input power failure, appliance failure, communications failure or configuration failure. This indicator may be a monitor or display such as a light, LED or LCD display, for example. The function of the visual indicator 290 is for human observation of status or anomaly and therefore may be visual in preferred form, or audio or wireless signaling such as BLUETOOTH® providing local notification separate from the radio transceiver 255 notifications of the device.

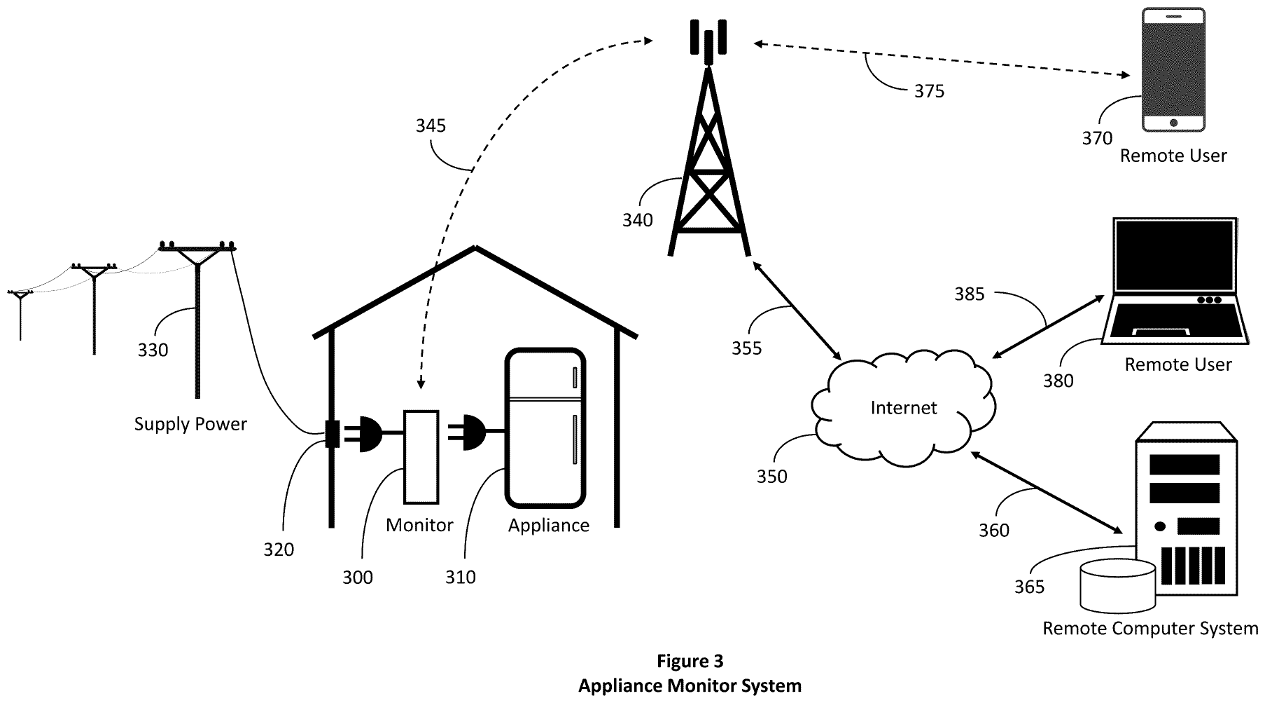

FIG. 3 illustrates an appliance monitoring system implementation utilizing the Monitor of FIGS. 1 and 2 and depicting an implementation for event notifications, status reporting and configuration control of the Monitor device. The system depicted details an example only for demonstrative purposes to better describe a typical installation and operation, and as such is not limiting in scope of the present invention.

FIG. 3 element 330 depicts a power utility service typical of delivering electrical power to any facility containing electrical appliances or equipment. This may be any electrical shore power service within the 90 to 250 volts range, for example. Service power is typically provided to a facility or structure through a power distribution panel to power receptacles 320 where equipment or appliances may be plugged in. In the example shown, the appliance 310 would normally be plugged directly into the wall receptacle 320, but as shown, the Monitor 300 is shown between shore power from the receptacle 320 and the appliance 310. This places the Monitor in series to for power delivery to the appliance 310, enabling monitoring shore power and appliance electrical current.

Monitor 300 communicates wirelessly 345 to long-range data service 340. This wireless interface may be any method of sending digital data between the Monitor and a network (e.g. the Internet 350) to include cellular service including but not limited to LTE, IoT, WiFi, WiMax and any variant thereof, BLUETOOTH®, Zigbee, or proprietary radio service performing data connectivity between a physical device and the internet.

The Internet 350 provides connectivity services between data processing components in the system. This may be the public internet used world-wide, or a private internet such as a closed network service, or proprietary networking service utilizing different technologies in the art. The Internet 350 is not a specific element of the present invention, but instead a networking function required for remote communications between a user or owner and the appliance being monitored.

The long-range wireless network 340 conveys bidirectional communications between a remote user or owner personal data device 370, which may be a tablet computer, cell phone or portable computing device equipped with wireless communications means. The Monitor device 300 may be equipped to communicate directly with the personal data device 370 to perform the outbound messaging from the Monitor 300 to the personal data device 370, to include status and notification reporting and the like. Similarly, the inbound messaging from the personal data device 370 to the Monitor 300 may include Monitor configuration settings, programmability of the Monitor 300 device, service commands such as appliance power termination as described for FIG. 2 element 285 power switch and the like. This direct connection method may not require any additional components to operate, and the controller functions as described in FIGS. 1 and 2 would be performed in the Monitor entirely or distributed between the Monitor 300 and the personal data device 370.

Additionally, FIG. 3 depicts a remote user 380 connected to the internet 350 using a connectivity 385. The connectivity 385 may be a wired or wireless or optical connection that results in the remote user 380 communicating bidirectionally with the Monitor over a combination of the internet 350 and long-range wireless connectivity 340. As with the personal data device 370, the function of the controller from FIGS. 2 and 3 may be performed exclusively in the Monitor 300 or a combination of the Monitor 300 and remote user computer 380.

Large system service may also employ a remote computer system or server 365 also connected to the internet 350 through some connectivity 360 which may be wired or wireless or optical. The remote computer system 365 may provide the same functionality of the remote user 380 system, but may also service millions of Monitor device data for millions of remote users. The remote computer system or server 365 may contain bulk storage, enabling data retention from every Monitor device connected. This large-scale bulk storage provides large historical data storage that may be infeasible in the Monitor 300 device alone, thus enabling temporal statistical analysis over larger data sets, and comparative analysis between multiple appliances of similar class. If the system includes the remote computer system or server 365, the preferred embodiment is for the remote computer system or server to perform as much of the controller function as possible in order to take advantage of the large data storage and comparative data capabilities for ascertaining anomalous appliance operation and notification. In this embodiment, the notifications and reports of events would originate from the remote computer system or server 365 and users or owners would receive notifications on personal data devices 370 or computers 380. Inbound communications to the Monitor may originate from any of the devices connected to the long-range wireless network associated with the system.

The system also provides for connectivity of one remote user 370 to multiple Monitors 300, as each Monitor has unique identification credentials. As such a single user 370 may own and operate as Monitor devices, receiving individualized notifications as configured. Similarly, the system supports multiple users monitoring a single, or set of Monitor devices thereby allowing families, or commercial associates to monitor critical equipment in parallel. Notifications of a single Monitor 300 are distributed to all users 370, 380 with account credentials associated with configuration setup in the Monitor service.

FIG. 3 therefore depicts a scalable implementation that minimally contains one Monitor 300 and one remote user 370 and one long-range radio system such as an LTE IoT network. The system also includes a world-wide deployment with tens of millions of Monitors and tens of millions of remote users. In each case, and every scale between, the ability for one user to monitor one or many appliances is provided.

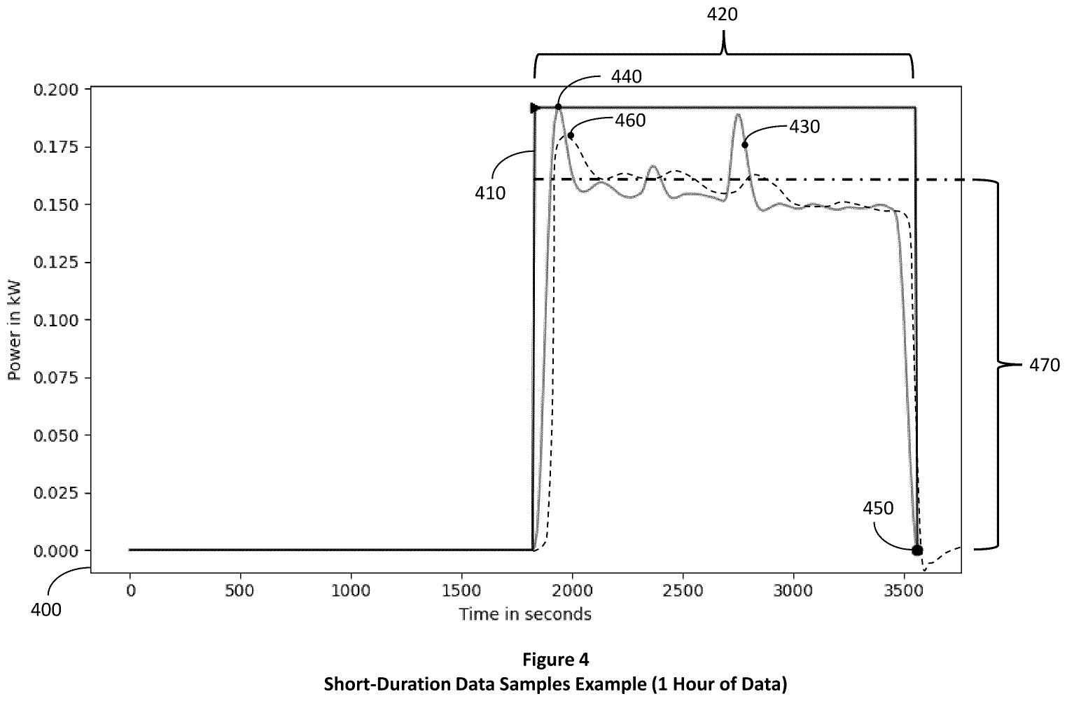

FIG. 4 depicts a short-duration data sample 400 example detailing the method for current measurement of the appliance electrical current performed within the Monitor device. The Monitor performs time-sampled data measurements from the current sensor 115, 215. This current sensor data presents a value proportional to the electrical operating current of the appliance. FIG. 4 depicts a waveform showing power of the appliance in kilowatts (KW) versus time in seconds. The raw-power line 430 depicts an appliance transitioning from a null power draw state from zero seconds through roughly 1800 seconds, then transitioning to a KW usage that contains overshoots and troughs through a run-event 420 cycle with time range of 1800 seconds. The controller performs measurements continuously detecting the change of power usage and creates an envelope of a run-event 420 to include the start-time of the event 410 and end-time of the event 450. The controller also calculates the mean power of the run-event envelope 470 which provides the appliance power draw for the run-event envelope time 420.

Raw current measurements 430 contain noisy fluctuations due to sampling noise, crosstalk interference in the Monitor, appliance current demand and wiring impedance of the utility and system. The fluctuations may lead to erroneous peak current measurement that may be reduced by applying filtering to the sampled waveform. FIG. 3 depicts application of a low-pass Butterworth filter to smooth the raw-power samples 430 to a smoothed sample set 460 for measurement. The exact filter applied may vary from one appliance type or installation requirement as needed. Filtering of noisy data is common, as may be appreciated by those skilled in the art. The present invention implements a single pole Butterworth filer in the preferred embodiment, though has other filters available for implementation via configuration.

The method depicted in FIG. 4 shows a data sample process whereby the controller function samples appliance current data, performs low-pass filter smoothing, then stores the data samples 460 for later use along with data components for start-time of run-event 410, stop-time of run-event 450, peak power of run-event 440, 460, and mean power of run-event 470.

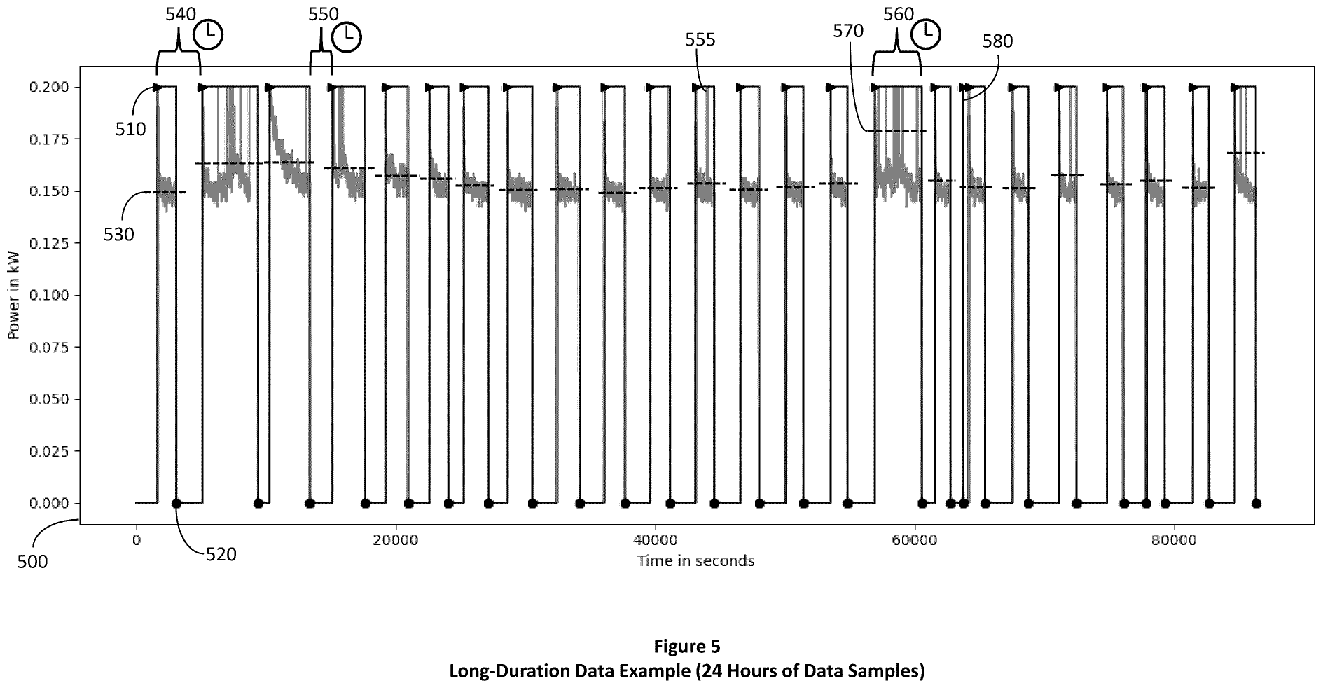

FIG. 4 also depicts a short-duration data sample of run-events. In the example depicted, the number of run events for the short-duration data sample is one. The duration of sample defined as short is relative, meaning that for a particular appliance or use case, the duration may be very short in seconds, or last for hours or days. Short-duration for the purposes of this disclosure shall mean a sample set of data spanning a time period much shorter than the historical (temporal) comparison long-duration data sample described in FIG. 5 below.

Samples collected in the short-duration capture may contain none, one or many run-events to be compared with long-duration capture of run-events containing at a minimum thirty run-events, ideally many more. The long-duration data represents enough data to statistically establish normal, historical operating conditions for comparison, thus ideally the long-duration data capture should contain hundreds of run-events to provide a smooth statistical distribution. By comparing recent appliance operation captured in the short-duration data with temporal appliance operation captured in the long-duration data, the controller may ascertain abnormal appliance operation.

FIG. 5 depicts a portion of a long-duration data sample 500 that includes twenty-four run-events of the appliance. Ideally, the long-duration data sample may contain at least thirty run-event samples or more to help smooth a distribution of a measurement. The example shown in FIG. 5 contains only twenty-four run-events but serves to describe the historical capture of appliance operation collected into the long-duration data sample.

The long-duration data sample contains historical data of the appliance connected to the Monitor. This long-duration data sample is data collected from a previous time, typically weeks, months or years prior to the data collected in the short-duration data sample. The purpose of the long-duration data sample is to establish a statistically significant set of operating parameters with enough data elements to create a smooth statistical or mathematical model for operation. Statistical analysis of data sets for establishing a false alarm rate with associated threshold is well known in the art and may include process such as histograms, cumulative distribution functions, Kalman predictive filtering, autoregressive integrated moving average (ARIMA) or similar that can be used to evaluate recent samples of operation with past appliance operation to ascertain if the appliance is operating today compared to past days, weeks, months or years.

FIG. 5 depicts a sample set of twenty-four run-events, which could be either a long-duration data set, or short-duration data set depending on if the data is recent (or current) or historical. The data elements collected in the long-duration data set are identical to those collected in the short-duration data set to enable temporal comparison. For example purposes, this FIG. 5 shall be discussed as a long-duration data set.

Each run-event is captured as discussed toward FIG. 4, where the Monitor controller function samples the appliance current data capturing the start-time of each run-event 510, stop-time of each run-event 520, peak power of run-event 550, and mean power of run-event 530, and run-event duration 560.

In addition to what was discussed in FIG. 3, the controller may also capture time duration intervals between run-events. These measurements were omitted in FIG. 3 discussion as that figure contained only one run-event, but the controller will compute these intervals between run-events as data is being captured for the short-duration which will eventually become long-duration data as it ages. FIG. 5 depicts these measurements between run-events as start-event to start-event time 540, stop-event to start-event time 550.

FIG. 5 depicts these run-events as KW power versus time, where power is calculated using electrical current measurement converted to power. This waveform is useful to provide a visual evaluation of creating a distribution of power usage, specifically mean power usage 530 for each run-event. For example, if the measurement parameter evaluated is mean power, the diagram shows the mean power for each run-event as a dashed line similar to the leftmost run-event mean depicted 530. Each run-event has its own mean power calculation, and the reader is directed to note that most of the run-events have similar mean power. One run-event has an abnormally large mean power 570 that may indicate anomalous appliance operation. The controller may perform statistical analysis using many run-events and different parameters measured to create a better assessment of true anomalous operation or if the deviation is within a normal range within the historical operating distribution.

Analysis of parameters measured may be treated independently, or as a group to ascertain appliance anomalous operation. For example, analysis of mean current is but one analysis technique. Others are evaluation of run-event duration 560 or interval of start-event to start-event time 540, stop-event to start-event time 550. Different appliances may operate differently, or more sporadically and may require different selection of parameter for analysis. For example, a refrigerator appliance may predominately idle at a low current and engage the compressor as needed for maintaining internal temperature. The current profile may appear very similar to that as depicted in FIG. 5, and the apparent single high mean current run-event 570 is a defrost cycle and therefore normal in operation. Increasing the size of the long-duration data set to include many defrost cycles will widen the distribution of what normal is for that specific appliance. Any of the sampled data parameters may be used to evaluate differences in the short-duration data set with the long-duration data set. If the parameter being measured is the stop-time to start-time of the next run-event interval, a short cycle condition 580 where the idle time is extremely small and us significantly outside in the long-duration data distribution, that event may be a candidate anomaly event.

Statistical analysis is the science of evaluating data sets for trends, variances and random elements. There are many mathematical methods for evaluating data to discover how a data element compares with a data set, or how a data set may have fundamental underlying components not readily available to the human eye. The present invention utilizes several statistical analysis methods known in the art to evaluate and compare a data element, or set of data elements to a different set of data elements. Specifically, the present invention may evaluate a single run-event, with associated event elements as discussed previously, against a larger set of previously sampled events. The time, or temporal, difference between the single event sample and the larger set of event data is used by the present invention to determine anomalous operation of the appliance. The present invention may also evaluate a small group of run-events recently sampled with a larger group of previously sampled events for similar anomaly determination.

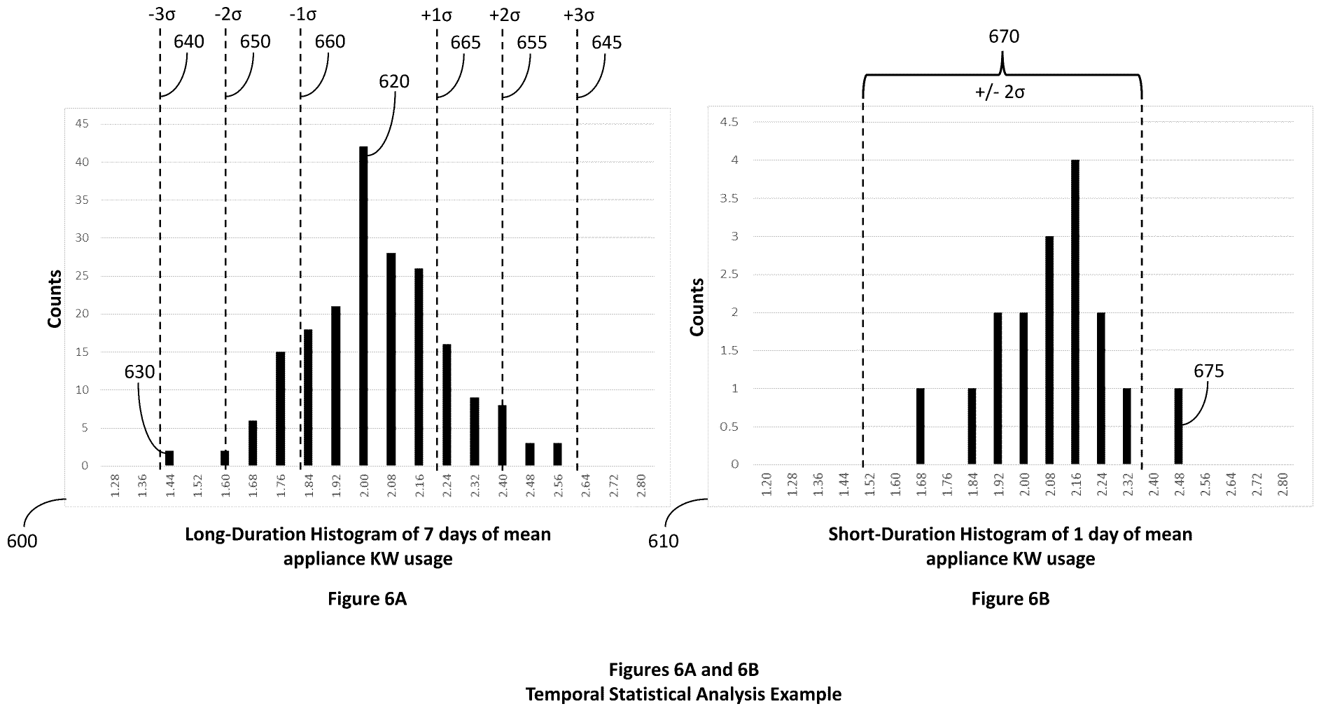

FIGS. 6A and 6B depict an example of temporal statistical analysis utilized in the present invention. In this example, the statistical analysis tool of a histogram is shown for both long-duration event data (6A), and short-duration event data (6B). A histogram is a rank count versus index graph, or table of data where the occurrence of a value in the data is counted into bins with bin values covering the range of the input data. The long-duration histogram 600 depicts 200 run-event data elements. These data elements may be any of the run-event measurements, such as mean power, run-event duration or the like. For the purposes of this example of FIG. 6A and FIG. 6B, the mean power data element is depicted, where the x-axis contains the range of power observed for all data elements, ranging from 1.28 MW to 2.8 KW with a bin resolution of 0.08 KW, creating 20 bin accumulations. Each bin accumulation represents a count of run-event mean power measurements that occur within the range of power for that bin. The y-axis of the graph is therefore the bin count.

Histogram 600 contains 200 counts total, with one count per data mean power element measured in the long-duration data set. This data represents historical measurements, from a time prior to recent samples and represents the normal operating mode for the appliance. In this example, this 200 element long-duration data set may be a 7-day period of collected data from the previous week, or a month ago, or a year ago.

Selecting the time value for historical comparison may be dependent on the appliance and setting. For example, if the appliance is a refrigerator that is located in an area exposed to outside environment with seasonal temperature change, it is probable that the refrigerator would run more often during the warm season than the cool season. In this instance, it may be preferable to select a time span of a year, with a long-duration data set window large enough to include data covering short-duration normal temperature swings. This method would create a long-duration data histogram containing elements that span minor temperature fluctuations common in any season and also major temperature fluctuations for the specific season. Comparing recently captured data to larger data set from a year ago, if available, can better identify anomalous operation of the appliance and minimize false alarm notifications due to seasonal fluctuations.

Conversely, if the appliance runs frequently enough to create a large run-event data set weekly, if may be preferable to set the time difference between the large-duration data and short-duration data at a week, whereby the system will track out seasonal changes automatically, notwithstanding very large temperature swings in a the short time-frame window.

For the purposes of the FIGS. 6A and 6B example, the long-duration histogram 600 contains seven days of event mean power data, sampled a week prior to the small-duration data histogram 610. The histogram will create a bin group distribution if the elements have any correlation in values. A set of data with pure random values will create a flat histogram, with the likelihood of a data element value equal to another equal to 0. Both histograms 600 and 610 demonstrate the mean power of the appliance is not random, with grouping centering near 2 KW. The long-duration histogram 600 contains 200 data elements, thus creates a smoother distribution with more apparent mean power 620 of 2 KW. The same appliance, when measured with a smaller data set containing 17 data elements as shown in the short-duration histogram 610 has a noticeable grouping but less well defined mean even though taken from the same appliance.

One method for evaluating run-event data elements for determining if they are significantly different than previously measured is to define a threshold method. A mathematical method for determining a threshold may be based on using the standard deviation of a data set as a baseline for probability of future occurrence. The term σ (Sigma) denotes the standard deviation of a data set and is measured in the range of values measured (the x-axis shown). The term μ (Mu) represents the mean value for a given data set. For a normal distribution, the occurrence of a data element with the range of μ+/−σ will contain 68.27% of all data elements. Stated differently, the likelihood of any single data element value measured to occur within 1σ of the mean (μ) is 68.27%. The standard deviation may therefore be used as a thresholding value for determining if any measured data sample, or samples is significantly different than the expected (mean) data from previous operation.

The threshold operation must be balanced to ideally determine all anomalous events, while simultaneously avoiding false detection of a normal run-event that is mis-characterized as an anomalous event. Setting the threshold also sets the false alarm rate, in that normal appliance operation occurs outside of a sigma value of 1. Setting a threshold as a multiple of σ can minimize false alarm rate but may also miss anomalous events for a given appliance. The Empirical Rule for thresholding using standard deviation methods uses 1σ, 2σ or 3σ, resulting in data likelihood groups of 68.27%, 95.45% and 99.73% respectively, however the multiplier to σ need not be integer.

For the example depicted in FIGS. 6A and 6B, three candidate thresholds are depicted, +/−1σ (660, 665), +/−2σ (650, 655) or +/−3σ (640, 645). These thresholds demonstrate the likelihood of run-events occurring within a given threshold within the long-duration run event data. For example, if a threshold of +/−1σ (660, 665) were to be used, 134 of the 200 data elements as shown are inclusive within +/−1σ range. Using this setting would result in 66 false anomalous determinations and alarm notifications. Similarly, a threshold of +/−2σ (650, 655) were to be used, 193 of the 200 data elements as shown are inclusive within +/−2σ range resulting in seven false anomalous determinations and alarm notifications. Similarly, a threshold of +/−3σ (640, 645) were to be used, all of the data elements as shown are inclusive within +/−3σ range resulting in zero false anomalous determinations and alarm notifications. The balance of threshold determination must be set by implementation to set the detection versus false detection rate applicable for user operation and annoyance of false alarms.

For example, the short-duration histogram 610 contains one day containing 17 run-event mean power data elements. An example threshold of +/−2σ would measure 16 of the data samples as typical operation, but one sample 675 would be outside the threshold, resulting in an anomalous detection and notification report. Because of the small size of the data set, it is unclear if the mean is actually 2 KW, or if this data element is actually outside a distribution, but comparing the data value 675 against the threshold created from the historical large-duration data set shows that while it is a low-probability event it remains in the well formed distribution of operation.

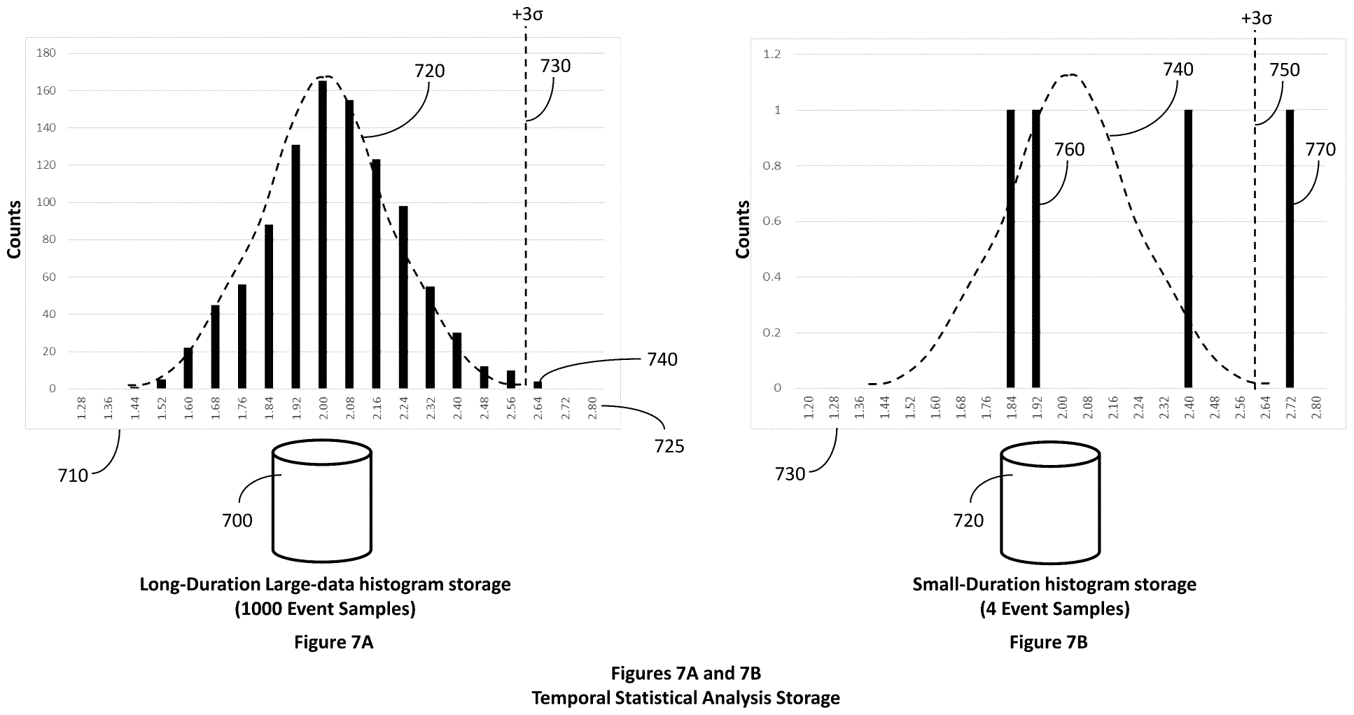

A large data set can greatly increase the quality of appliance operation characteristics. FIGS. 7A and 7B depict a large-duration, historical data set 700 containing 1000 run event data samples. This data set may become very large, containing thousands or millions of data samples. The data set may become too large for storage on a local processor controller of a Monitor, and may also be distributed as storage to a remote computer system or server. Larger data sets create smoother, more defined distribution envelopes 720, and thus create a better quality of threshold determination 730. For example, if the user or system wishes to limit false alarms to less than 0.3%, selecting a threshold value of +/−3σ calculated from the measure data set would be of higher quality than the same calculation from a smaller data set. This threshold applied to the large 1000 sample historical would result in 4 false alarms in 1000 samples (0.4%). Note the measured false alarm rate is higher than the expected 0.27% rate. The expected false alarm rate is not a limit, but a statistical mean false alarm rate based on an infinite number of data points in a distribution.

A threshold may be applied to any smaller data sample for determination of anomalous operation. A single, or small group of run-events may be compared to thresholds set as described to determine anomalous operation. The small-duration data histogram 730 depicts a set of four run-event sample mean power measurements overlaid with the smoothed distribution curve 740 and the +/−3σ threshold 750 derived from the large-duration histogram 700. Data elements inside the +/−3σ threshold would pass analysis, however the data element 770 is well outside the +/−3σ threshold 750 and would be determined to be an indication of anomalous appliance operation.

All data sampled for small-duration analysis are stored 720 and will eventually be candidates for use in large-duration analysis as it ages, depending on the temporal span applicable for the appliance or operating environment.

It should be noted that a smaller sample may be a single run-event, or a small group of run-events, or even a large group of run events. It may be advantageous to evaluate a large set of recently measured data against a large set of temporal, historical data. For example, for a given appliance with a typical mean run power, it may be possible to determine a change of mean power measured today compared to a mean power measured a year ago which may indicate a pending failure of an appliance. This is a typical failure mode for electric motors where full-run-current will increase at motor end of life and could be detected using temporal statistical analysis comparison of mean power, provided the mean power measurements were of sufficient quality.

Yet another thresholding method for temporal statistical analysis is use of cumulative distribution function (CDF). A cumulative distribution function is similar to a histogram in creation, except each count bin for events occurring in the range of the bin are accumulated with the bin values of lower bin range. This creates an accumulating curve that ranges from 0% to 100% the sample set size.

FIGS. 8A and 8B depict the same 1000 data elements as described for FIGS. 7A and 7B except that they are graphed as CDF versus a histogram. The axis remain the same as counts versus KW mean power, but the counts increase as the bin power values increase, with each bin equal to bin count plus the lower power bins counts eventually reaching 1000 counts by the 2.64 KW bin. This same curve when plotted against a ratio of samples is also known as a probability distribution function (PDF) where a threshold may be applied that sets the likelihood of a given sample below a threshold equal to the ratio of the curve at that point. For example, a system may wish to set a 2% false alarm rate, whereby an average of 2% of data samples would be outside the limit. As depicted, the 2% rate would be where a total of 2% of the 1000 data sample values are below or above a threshold.

As shown in the example of FIGS. 7A and 7B, the same short-duration samples would similarly pass three of the captured elements 850 but fail the mean power 870 that exceeds the 2% threshold limit.

A cumulative distribution threshold approach yields identical thresholds with a standard deviation threshold approach for distributions that that are normal, where normal distributions are defined as symmetrical about the mean of the distribution, such as a Gaussian distribution. Appliances may however have operation that create asymmetric data sets and therefore create skewed distributions that may require different upper or lower thresholds. A cumulative distribution threshold can be used to create thresholds from large-duration data sets that set lower and upper thresholds to empirical data rather than standard deviation calculation.

For example, if an appliance is a pump with a mean power dominated by electric motor operation, a mean power distribution may be symmetrical, thus applicable for upper and lower thresholds set by common multiplier of measured standard deviation. However, if the appliance is a refrigerator with mean power dominated by compressor operation use of a common upper and lower threshold may create false alarms when the refrigerator defrost cycle occurs in addition to the compressor running. The mean power distribution upper limit may need to be adjusted to accommodate the additional power for compressor plus defroster versus compressor only on the lower limit. In this case separate thresholds may be calculated using a cumulative distribution function as described.

Yet another thresholding method for temporal statistical analysis is use of predictive analytics, utilizing all historical data from a device to create a model for operation that includes seasonal variations and trends. A method such as autoregressive integrated moving average (ARIMA) or Kalman filtering may be applicable to create customized predictive models that create dynamic thresholds based on the model tracking function. This approach may be applicable depending on the appliance monitored. The present invention may utilize ARIMA or the like as applicable to the appliance monitored.

Although the figures illustrate different examples of user equipment, various changes may be made to the figures. For example, the user equipment can include any number of each component in any suitable arrangement. In general, the figures do not limit the scope of this disclosure to any particular configuration(s). Moreover, while figures illustrate operational environments in which various user equipment features disclosed in this patent document can be used, these features can be used in any other suitable system.

Some of the illustrative aspects of the present invention may be advantageous in solving the problems herein described and other problems not discussed which are discoverable by a skilled artisan.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

It should be noted that the steps described in the method of use can be carried out in many different orders according to user preference. The use of “step of” should not be interpreted as “step for”, in the claims herein and is not intended to invoke the provisions of 35 U.S.C. § 112(f). Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

Users may download an application on their mobile phones, tablets or any other mobile computing device, and even a vehicle.

The foregoing disclosure provides illustration and description, but is not intended to be exhaustive or to limit the implementations to the precise form disclosed. Modifications and variations are possible in light of the above disclosure or may be acquired from practice of the implementations.

As used herein, the term component is intended to be broadly construed as hardware, firmware, and/or a combination of hardware and software.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware can be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Furthermore, as used herein, the term “set” is intended to include one or more items (e.g., related items, unrelated items, a combination of related items, and unrelated items, etc.), and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

As may be used herein, the terms “substantially” and “approximately” provides an industry-accepted tolerance for its corresponding term and/or relativity between items. Such an industry-accepted tolerance ranges from less than one percent to fifty percent. As may also be used herein, the term(s) “operably coupled to”, “coupled to”, and/or “coupling” includes direct coupling between items and/or indirect coupling between items via an intervening item (e.g., an item includes, but is not limited to, a component, an element, a circuit, and/or a module). As may further be used herein, inferred coupling (i.e., where one element is coupled to another element by inference) includes direct and indirect coupling between two items in the same manner as “coupled to”. As may even further be used herein, the term “operable to” or “operably coupled to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item. As may be used herein, the term “compares favorably”, indicates that a comparison between two or more items, signals, etc., provides a desired relationship.

As may also be used herein, the terms “processor”, “module”, “processing circuit”, and/or “processing unit” (e.g., including various modules and/or circuitries such as may be operative, implemented, and/or for encoding, for decoding, for baseband processing, etc.) may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module, module, processing circuit, and/or processing unit may have an associated memory and/or an integrated memory element, which may be a single memory device, a plurality of memory devices, and/or embedded circuitry of the processing module, module, processing circuit, and/or processing unit. Such a memory device may be a read-only memory (ROM), random access memory (RAM), volatile memory, non-volatile memory, static memory, dynamic memory, flash memory, cache memory, and/or any device that stores digital information. Note that if the processing module, module, processing circuit, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processing module, module, processing circuit, and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processing module, module, processing circuit, and/or processing unit executes, hard coded and/or operational instructions corresponding to at least some of the steps and/or functions illustrated in one or more of the Figures. Such a memory device or memory element can be included in an article of manufacture.

The present invention has been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention. One of average skill in the art will also recognize that the functional building blocks, and other illustrative blocks, modules and components herein, can be implemented as illustrated or by discrete components, application specific integrated circuits, processors executing appropriate software and the like or any combination thereof.

The present invention may have also been described, at least in part, in terms of one or more embodiments. An embodiment of the present invention is used herein to illustrate the present invention, an aspect thereof, a feature thereof, a concept thereof, and/or an example thereof. A physical embodiment of an apparatus, an article of manufacture, a machine, and/or of a process that embodies the present invention may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

Unless specifically stated to the contra, signals to, from, and/or between elements in a figure of any of the figures presented herein may be analog or digital, continuous time or discrete time, and single-ended or differential. For instance, if a signal path is shown as a single-ended path, it also represents a differential signal path. Similarly, if a signal path is shown as a differential path, it also represents a single-ended signal path. While one or more particular architectures are described herein, other architectures can likewise be implemented that use one or more data buses not expressly shown, direct connectivity between elements, and/or indirect coupling between other elements as recognized by one of average skill in the art.

The term “module” is used in the description of the various embodiments of the present invention. A module includes a functional block that is implemented via hardware to perform one or module functions such as the processing of one or more input signals to produce one or more output signals. The hardware that implements the module may itself operate in conjunction software, and/or firmware. As used herein, a module may contain one or more sub-modules that themselves are modules.

While particular combinations of various functions and features of the present invention have been expressly described herein, other combinations of these features and functions are likewise possible. The present invention is not limited by the particular examples disclosed herein and expressly incorporates these other combinations.

The embodiments of the invention described herein are exemplary and numerous modifications, variations and rearrangements can be readily envisioned to achieve substantially equivalent results, all of which are intended to be embraced within the spirit and scope of the invention. Further, the purpose of any included abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

The above description provides specific details, such as material types and processing conditions to provide a thorough description of example embodiments. However, a person of ordinary skill in the art would understand that the embodiments may be practiced without using these specific details.

Some of the illustrative aspects of the present invention may be advantageous in solving the problems herein described and other problems not discussed which are discoverable by a skilled artisan. While the above description contains much specificity, these should not be construed as limitations on the scope of any embodiment, but as exemplifications of the presented embodiments thereof. Many other ramifications and variations are possible within the teachings of the various embodiments. While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best or only mode contemplated for carrying out this invention, but that the invention will include all embodiments falling within the scope of the appended claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

1. An electronic device comprising:
(a) a voltage converter configured to accept power from an external voltage source, and convert the voltage for device operation;
(b) a rechargeable battery configured to provide voltage for device operation upon failure of the external voltage source;
(c) a power manager configured to provide continuous voltage for device operation using voltage from at least one of the voltage converter and the rechargeable battery, and to manage a recharge operation of the rechargeable battery;
(d) a current sensor configured to measure electrical current drawn by an external appliance, and to provide a sensor voltage output based upon an external appliance load current;
(e) a wireless transceiver with associated antenna configured to enable the device to communicate device operational and sensor data, and to receive device configuration settings from an external management system utilizing wireless communication; and
(f) a controller configured to
monitor device voltage inputs of the voltage converter,
monitor rechargeable battery status and operation controlled by the power manager,
monitor sensor voltage output from the current sensor,
perform temporal statistical analysis processes to ascertain anomalous operation of the external appliance, and
report, via the wireless transceiver, anomalous operation of the external appliance, anomalous power input from the external voltage source, and operational status of the electronic device.

2. The electronic device of claim 1, further comprising an electrical plug coupled to the voltage converter and configured to plug directly into an electrical wall receptacle.

3. The electronic device of claim 1, further comprising an electrical outlet coupled to the current sensor and configured to connect to the external appliance.

4. The electronic device of claim 1, wherein the voltage converter is configured to accept an AC input voltage between 90 to 250 Volts.

5. The electronic device of claim 1, further comprising an appliance power switch configured to disable output power to the external appliance; wherein said appliance power switch is operated by the controller.

6. The electronic device of claim 1, further comprising a low voltage detector configured to provide a low voltage detection signal to the controller upon detection of improper voltage levels present on the external voltage source.

7. The electronic device of claim 1, further comprising a temperature sensor, heater and associated heater switch together, operated by the controller, to provide temperature regulation to maintain minimum operating temperature of the electronic device operation within a suitable temperature range of the rechargeable battery.

8. The electronic device of claim 1, wherein the wireless transceiver with associated antenna is configured to operate over at least one of cellular IoT LTE wireless networks, WiFi wireless network, Bluetooth wireless networks, and Zigbee wireless networks.

9. The electronic device of claim 1, wherein the temporal statistical analysis processes to ascertain anomalous operation of the external appliance includes comparative processes comparing recent to past statistical run intervals to determine if the external appliance is running too frequently, not running frequently enough, a run duration is too long, a run duration is too short, is running continuously, and/or has failed to run.

10. The electronic device of claim 1, wherein the report operational status includes system notification of external voltage source power failure, rechargeable battery failure, wireless transceiver intermittent failure, external appliance running start event, and/or external appliance running stop event.

11. The electronic device of claim 1, wherein the device configuration settings received from the external management system include over-the-air controller software reprogram.

12. The electronic device of claim 1, further comprising an appliance power switch configured to disable output power to the external appliance; wherein said appliance power switch is operated by the controller; and wherein the device configuration settings from the external management system includes over-the-air appliance power switch control.

13. The electronic device of claim 1, further comprising a visual indicator, coupled to the controller, and configured to provide a human visible indication of at least one operation.

14. The electronic device of claim 13, wherein the device configuration settings from an external management system includes over-the-air visual indicator control.

15. A system for detecting anomalous operation of an electrical appliance, the system comprising:
(a) a current measurement module to perform sampled measurements of operating current of an appliance to include event data elements of:
(i) detection of change of appliance current value denoting an appliance start event time;
(ii) detection of change of appliance current value denoting an appliance stop event time;
(iii) calculating a peak current for a run event defined by the appliance start event time and the appliance stop event time;
(iv) calculating a mean current for the run event;
(v) measuring a run duration of the run event; and
(vi) measuring an idle duration between run events; and
(b) a data storage configured to store measured sampled voltage and event data elements;
(c) a temporal statistical comparative analysis module configured to create a first long-duration histogram of historical run event data previously measured from the electrical appliance to include a minimum amount of event data sets, and configured to create a second short-duration histogram of historical run event data previously measured from the electrical appliance to include at least one run event data set including a most recent sample;
(d) a thresholding module configured to compare and determine if at least one of the data bin indexes of the second short-duration histogram exceeds a calculated statistical threshold thus detecting anomalous appliance operation;
(e) a long-range reporting module configured to enable data communication between the current measurement module and a remote computer system; and
(f) a communication module configured to communicate detected anomalous operational events, anomalous voltage measurements, and anomalous current measurements to the remote computer system.

16. The system of claim 15, further comprising a voltage measurement module configured to perform sampled measurements of operating voltage of the electrical appliance to detect an appliance supply power fail event.

17. The system of claim 16, further comprising a voltage disable module coupled to the voltage measurement module and configured to disable operation of the electrical appliance.

18. The system of claim 15, wherein the current measurement module further includes performing low-pass filter operations to create smoothed data samples, and using the smoothed data samples for measuring event data elements for peak current and mean current.

19. The system of claim 15, further comprising a visual indicator configured to provide human visible indication of at least one operation.

20. The system of claim 15, wherein the thresholding module further include:
(a) calculating a standard deviation value of the long-duration histogram data;
(b) creating a calculated statistical threshold by multiplying the calculated standard deviation with a pre-defined threshold value; and
(c) determining if at least one of the short-duration histogram data indexes exceeds the calculated statistical threshold.

21. The system of claim 20, wherein the pre-defined threshold value is derived from large-duration histogram data from many assets of similar electrical appliances.

22. The system of claim 15, wherein the thresholding module further includes:
(a) calculating a cumulative distribution function of the long-duration histogram data;
(b) creating a calculated statistical threshold by determining a bin index in the cumulative distribution function equal to a pre-defined false alarm rate; and
(c) determining if at least one of the short-duration histogram data indexes exceeds the calculated statistical threshold.

23. The system of claim 22, wherein the pre-defined false alarm rate is derived from large-duration histogram data from many assets of similar electrical appliances.

24. The system of claim 15, wherein the long-range reporting module operates over at least one of a cellular IoT LTE wireless network, a WiFi wireless network, Bluetooth wireless network, and a Zigbee wireless network.

25. The system of claim 15, wherein the temporal statistical comparative analysis module is configured to:
(a) create the first long-duration histogram of historical run event duration data by subtracting the appliance start event time from the appliance stop event time of the run event; and
(b) create a second short-duration histogram of historical run event duration data by subtracting the appliance start event time from the appliance stop event time of the run event; and
(c) apply threshold methods to determine at least one of a run duration anomalous short cycle event and a run duration anomalous long cycle event.

26. The system of claim 15, wherein the temporal statistical comparative analysis module is configured to:
(a) create the first long-duration histogram of historical run event interval data calculated by subtracting the appliance start event time of a run event from the appliance start event time of a most previous run event; and
(b) create a second short-duration histogram of historical run event duration data calculated by subtracting the appliance start event time of a run event from the appliance start event time of a most previous run event; and
(c) apply threshold methods to determine at least one of an anomalous appliance running-too-frequently event and anomalous appliance running-too-infrequently event.

27. The system of claim 15, wherein the temporal statistical comparative analysis module includes a run event timer configured to measure an appliance run time starting with a change of appliance current value detection; and
wherein the temporal statistical comparative analysis module is configured to:
(a) create a first long-duration histogram of historical run event time;
(b) create a second short-duration histogram of historical run event mean current measurements; and
(c) apply threshold methods to determine an anomalous appliance low-current event.

28. The system of claim 15, wherein the temporal statistical comparative analysis module is configured to:
(a) create a first long-duration histogram of historical run event mean current measurements;
(b) create a second short-duration histogram of historical run event mean current measurements; and
(c) apply threshold methods to determine an anomalous appliance high-current event.

29. The system of claim 15, wherein the temporal statistical comparative analysis module is configured to:
(a) create a first long-duration histogram of historical run event peak current measurements;
(b) create a second short-duration histogram of historical run event peak current measurements; and
(c) apply threshold methods to determine an anomalous appliance high-peak current event.

30. The system of claim 15, wherein the temporal statistical comparative analysis module is configured to:
(a) create a first long-duration histogram of historical run duration measurements;
(b) create a second short-duration histogram of historical run duration measurements; and
(c) apply threshold methods to determine an anomalous appliance running continuously event.

31. The system of claim 15, wherein the temporal statistical comparative analysis module is configured to:
(a) create a first long-duration histogram of historical idle duration measurements;
(b) create a second short-duration histogram of historical idle duration measurements; and
(c) apply threshold methods to determine an anomalous appliance not running event.

32. The system of claim 15, wherein the long range reporting module is further configured to:
(a) store reports with an associated time tag of a report generation time;
(b) detect failure of data communications;
(c) send stored data upon restored operational service; and
(d) reporting failure of data communications upon restored operational service.

33. The system of claim 15, wherein the thresholding module is further configured to qualify a derived threshold for detection of anomalous appliance operation using autoregressive integrated moving average methods.
